(19) United States
(12) Patent Application Publication
(10) Pub. No.: US 2018/0336982 A1
(43) Pub. Date: Nov. 22, 2018

(54) Fe-Si Base Alloy and Method of Making Same

(71) Applicant: CRS HOLDINGS, INC., Wilmington, DE (US)

(72) Inventors: Chins Chinnasamy, Lancaster, PA (US); Samuel J. Kernion, Lancaster, PA (US); Eric Fitterling, Macungie, PA (US); Alberto Polar-Rosas, Reading, PA (US); Tao Wang, Reading, PA (US)

(21) Appl. No.: 15/982,432

(22) Filed: May 17, 2018

Related U.S. Application Data
(60) Provisional application No. 62/507,415, filed on May 17, 2017.

(51) Int. Cl. H01F 1/147; C22C 38/34; C22C 38/32; C22C 38/30; C22C 38/04; C21D 8/12

(52) U.S. Cl. CPC H01F 1/14775; C22C 38/34; C21D 8/1222; C22C 38/30; C22C 38/04; C22C 38/32

(57) ABSTRACT

A soft magnetic alloy having a good combination of formability and magnetic properties is disclosed. The alloy has the formula

Fe_{100-a-b-c-d-e-f}SiₐM_{b}L_{c}M′_{d}M″ₑR_{f}

wherein M is Cr and/or Mo; L is Co and/or Ni; M′ is one or more of Al, Mn, Cu, Ge, Ga; M″ is one or more of Ti, V, Hf, Nb, W; and R is one or more of B, Zr, Mg, P, Ce. The elements Si, M, L, M′, M″, and R have the following ranges in weight percent:

| | |
|---|---|
| Si | 4-7 |
| M | 0.1-7 |
| L | 0.1-10 |
| M′ | up to 7 |
| M″ | up to 7 |
| R | up to 1 |

The balance of the alloy is iron and usual impurities. A thin-gauge article made from the alloy and a method of making the thin-gauge article are also disclosed.

### CROSS-REFERENCE TO RELATED APPLICATION

This application claims the benefit of U.S. Provisional Application No. 62/507,415, filed May 17, 2017, the entirety of which is incorporated herein by reference.

### BACKGROUND OF THE INVENTION

### Field of the Invention

This invention relates to soft magnetic alloys containing Fe and Si and in particular, to a soft magnetic Fe—Si alloy containing one or more additive elements to benefit the ductility and formability of the alloy.

### Description of the Related Art

Iron-silicon (Fe—Si) steel sheet containing 6.5-7% silicon features excellent magnetic properties, including greatly reduced core loss at high frequencies and very low magnetostriction compared to Fe—Si steel sheet containing less than 4% Si. Because of those characteristics, Fe—Si steel sheet containing nominal 6.5% Si has high potential for use in various electrical devices and shielding applications, including cores for transformers and the stators and rotors of motors and generators. Such a material would offer advantages of weight reduction, vibration reduction, and noise reduction, as well as electric power savings. However, the presence of ordered phases in the nominal 6.5% Si steel alloy, namely the B2 (FeSi) and D0₃ (Fe₃Si) phases, causes embrittlement of the steel alloy at room temperature. The lack of adequate ductility and formability makes it difficult to process the alloy into thin sheet, strip, or foil form by conventional processes such as cold rolling, warm rolling, and hot rolling. When the Si content is more than 4 wt. %, the percent elongation decreases rapidly and conventional cold rolling techniques cannot be readily used.

In order to avoid the adverse effect of higher silicon on the formability of the steel alloy, special processing techniques have been used. Such techniques include strict temperature controls and strict limitations on reductions in thickness during hot, warm, and/or cold working steps. Another technique includes the application of a siliconized layer to Fe—Si steel strip by chemical vapor deposition (CVD). However, such techniques unduly increase the cost of producing Fe—Si steel strip and sheet.

In view of the state of the art, it would be desirable to be able to produce Si-rich, Fe—Si electrical steel strips and sheets of various thicknesses that have excellent magnetic characteristics such as high saturation induction, low coercivity, high permeability, high electrical resistivity, low magnetostriction, and low core loss at high frequencies. It would also be desirable to produce such Si-rich, Fe—Si alloy products by using conventional metallurgical techniques and processes to obtain the above-described magnetic characteristics for use in the production of soft magnetic laminated cores with reduced weight, low energy losses, and low cost for the next generation of electromagnetic devices such as motors, generators, transformers, inductors, choke coils, actuators, fuel injectors, compressors, and other electromotive devices.

### SUMMARY OF THE INVENTION

In accordance with a first aspect of the present invention there is provided an alloy that resolves the processing disadvantages of the known Fe—Si materials. The alloy according to the present invention can be defined by the chemical formula Fe_{100-a-b-c-d-e-f}SiₐM_{b}L_{c}M′_{d}M″ₑR_{f} where M is one or both of Cr and Mo; L is one or both of Co and Ni; M′ is selected from the group consisting of Al, Mn, Cu, Ge, Ga, and a combination thereof; M″ is selected from the group consisting of Ti, V, Hf, Nb, W, and a combination thereof; and R is selected from the group consisting of B, Zr, Mg, P, Ce, and a combination thereof. The alloy is further defined by the following weight percent ranges for the constituent elements.

| | Broad | Intermediate | Preferred |
|---|---|---|---|
| Si | 4-7 | 4-7 | 4-7 |
| M | 0.1-7 | 0.5-6 | 1-5 |
| L | 0.1-10 | 0.5-7 | 0.75-6 |
| M′ | up to 7 | up to 5 | 0.1-3 |
| M″ | up to 7 | 5 max. | 3 max. |
| R | up to 1 | up to 1 | up to 1 |

The balance of the alloy is iron and usual impurities.

In accordance with a second aspect of the present invention there is provided an alloy product that is made from the alloy described above. The alloy product is characterized by a microstructure consisting essentially of at least about 1 vol. % and better yet at least about 15 vol. % of a disordered bcc phase. Preferably the alloy product contains about 75 vol. % to about 100 vol. % of the disordered phase.

In accordance with another aspect of the present invention there is provided a process for producing thin-gauge silicon iron sheet and strip containing more than 2.5% Si from the Fe—Si alloy described above. The process according to this invention includes the following steps. Melting and casting the alloy followed by thermomechanically processing the alloy after it has solidified to provide an elongated, intermediate form. The elongated intermediate form is then cooled from a temperature above the order-disorder transition temperature at a cooling rate that is effective to inhibit the formation of the ordered bcc phase.

The foregoing tabulation is provided as a convenient summary and is not intended to restrict the ranges of the elements for use solely within the broad, intermediate, and preferred embodiments as set forth in the table. Thus, one or more of the ranges of the broad, intermediate, or preferred embodiments can be used with one or more of the ranges of a different embodiment for the remaining elements. In addition, a minimum or maximum for an element of one of the broad, intermediate, or preferred compositions can be used with the minimum or maximum for the same element in a different embodiment.

Here and throughout this specification the following definitions apply. The term “percent” and the symbol “%” mean weight percent or mass percent unless otherwise indicated. The term “vol. %” means percent by volume. The term “thin gauge” or “thin-gauge” means a thickness of not more than about 0.08 inches (2.03 mm). The term “additive element” means one or more elements added to the base alloy in an amount sufficient to provide a desired effect on one or more properties.

### DETAILED DESCRIPTION

The alloy according to this invention is an iron-silicon base alloy that can be defined by having the following general chemical formula:

Fe_{100-a-b-c-d-e-f}SiₐM_{b}L_{c}M′_{d}M″ₑR_{f}

Silicon: This alloy contains at least about 4% silicon to benefit the magnetic properties provided by the alloy. In particular, silicon reduces the core loss at high operating frequencies and significantly lowers the magnetostriction of the alloy. Too much silicon promotes the formation of the ordered phases B2 and D0₃, both of which result in embrittlement of the alloy, and a consequent loss of ductility. Therefore, the alloy contains not more than about 7% silicon to inhibit the formation of such phases.

M: M is one or both of chromium and molybdenum. Chromium and molybdenum benefit the ductility of the alloy particularly at elevated temperatures at which elongated forms of the alloy are warm rolled. M retards the order-disorder transformation reaction during the cooling process. In this manner, the formation of ordered bcc phases such as B2 and D0₃ is inhibited. M also reduces the ductile-to-brittle transition temperature of the alloy which allows the alloy to be cold rolled at lower temperatures than the known Si—Fe alloys. Toward those ends, the alloy contains at least about 0.1% of one or both of chromium and molybdenum. Preferably, the alloy contains at least about 0.5% and for best results, at least about 1% Cr+Mo. Chromium and molybdenum are restricted to not more than about 7% in order to avoid an adverse effect on the magnetic properties provided by the alloy. Preferably, the alloy contains not more than about 6% Cr+Mo and better yet not more than about 5% Cr+Mo

L: L is cobalt, nickel, or a combination thereof. Cobalt and/or nickel are present in this alloy to benefit the soft magnetic properties provided by this alloy. More specifically, the L elements increase the Curie temperature of the alloy which extends its magnetic behavior over a broader temperature range. Cobalt and nickel also increase the magnetic saturation induction of the alloy, and provide an increase in permeability. Accordingly, the alloy contains at least about 0.1% and preferably at least about 0.5% of one or both of cobalt and nickel. Good results have been obtained when this alloy contains at least about 0.75%, for example, at least about 0.85% Co+Ni. For best results, the alloy contains at least about 1% Co+Ni. Too much cobalt and/or nickel eventually increases the magnetocrystalline anisotropy and the magnetostriction of the alloy. Too much cobalt and/or nickel may also increase the core loss to an undesirable level. Therefore, the alloy contains not more than about 10%, better yet, not more than about 7%, and preferably contains not more than about 5% or 6% of Ni+Co.

M′: M′ is selected from the group consisting of aluminum, manganese, copper, germanium, gallium, and a combination thereof. Up to about 7% of M′ may be present in this alloy to benefit the electrical and magnetic properties provided by the alloy. When present M′ increases the electrical resistivity of the alloy, increases the magnetic permeability of the alloy, and lowers the coercive force. Preferably the alloy contains at least about 0.1% of M′. Too much M′ adversely affects the magnetic properties of the alloy such as the magnetic saturation induction. Therefore, the alloy preferably contains not more than about 5% and better yet, not more than about 4% of M′.

M″: M″ is selected from the group consisting of titanium, vanadium, hafnium, niobium, tungsten, and a combination thereof. Up to about 7% of M″ may be present in the alloy. When present M″ benefits the ductility of the alloy by retarding the formation of embrittling ordered phases in the alloy when the alloy is cooled. Too much M″ adversely affects the magnetic properties provided by the alloy, particularly the magnetic saturation induction provided by the alloy. Therefore, the alloy preferably contains less than about 5% and better yet less than about 3% of M″.

R: R is one or more of the elements boron, zirconium, magnesium, phosphorus, and cerium. A small amount up to about 1% of R may present in this alloy for grain refinement and to strengthen grain boundaries in the alloy during the forming process, where a preferred grain size of ASTM 5 or finer is desired.

The balance of the alloy is iron and the usual impurities present in commercial Fe—Si alloys intended for similar use or service. Carbon, nitrogen, and sulfur are considered impurities in this alloy because they are known to form carbides, nitrides, carbonitrides, or sulfides. Such phases can adversely affect the magnetic properties that are characteristic of the alloy. Therefore, the alloy contains not more than about 0.1% carbon, not more than about 0.1% nitrogen, and not more than about 0.1% sulfur. Preferably, the alloy contains not more than about 0.005% each of carbon, nitrogen, and sulfur when the alloy includes carbide-, nitride-, carbonitride-, and/or sulfide-forming elements.

Because of the alloying of the additive elements L and M and the optional elements M′, M″, and R with Fe and Si, an alloy product according to the present invention contains at least about 1 vol. % of the disordered bcc phase. Preferably the alloy product contains at least about 75 vol. % of the disordered phase. In a particular embodiment, the alloy product consists essentially of the disordered phase only, i.e., about 100 vol. % disordered bcc phase. It has been found that the presence of the disordered phase and a minimal amount of the ordered phase(s) might have beneficial effects on the plasticity of the alloy which results in improved formability, particularly cold formability. For most applications, the alloy product can be characterized by a microstructure containing disordered phases such as A2 in the range of 75 to about 100 vol. % whereby the magnetic properties of the alloy product are expected to be significantly improved relative to the known Fe—Si steel.

An intermediate form of alloy article according to this invention is produced in the form of thin-gauge sheets and strips having thicknesses of 0.0001 in. (2.54 μm) to about 0.1 in. (2.54 mm). Preferred thicknesses include 0.002 in. (0.0508 mm), 0.005 in. (0.127 mm), 0.007 in. (0.178 mm), 0.010 in. (0.254 mm), 0.014 in. (0.356 mm), 0.019 in. (0.483 mm) and 0.025 in. (0.635 mm). The width of the sheet or strip product depends on the application in which the alloy will be used. Typically, the alloy article would be about 0.5 to 40 inches (12.7 mm to 101.6 cm) in width for most applications.

The alloy article according to the present invention is preferably produced by first melting and casting the alloy into an ingot. After solidification, the ingot is thermomechanically processed as by hot and/or warm rolling to form an intermediate elongated product form having a thickness that is less than 2 in. (5.08 cm) but more than 0.05 in (1.27 mm). The hot or warm rolling step is carried out on the intermediate elongated product at in a temperature range that is selected to avoid tearing or cracking of the alloy. Preferably, hot rolling is carried out from a starting temperature of at least about 2102° F. (1150° C.) to a finish temperature not lower than about 1472° F. (800° C.). Warm rolling is preferably carried out from a starting temperature of at least about 1112° F. (600° C.) to a finish temperature of not less than about 302° F. (150° C.). In another embodiment, the intermediate elongated product can be made by strip casting the alloy.

The intermediate elongated product is then cooled at a rate that is selected to inhibit the possible formation of ordered phases as the alloy cools to room temperature. Optionally, that alloy can be quenched in water, oil, gas, or in any other suitable quenching media from a temperature above the order-disorder transition temperature to avoid the formation of the ordered phases.

After the cooling step, the intermediate elongated form is further reduced in thickness by cold or warm rolling. The cold or warm rolling step is carried out in one or more passes to provide a second elongated having the desired final thickness. The warm rolling step is conducted at temperatures similar to those described above for the thermomechanical working step. The second elongated form of the alloy can be further processed into useful finished or semi-finished parts such as laminations and other stampings. The finished or semi-finished parts can be heat treated to relieve stresses induced in the material during part fabrication or to promote phase transformation. The preferred heat treating temperature for stress relieving is in the range of 752−1382° F. (400-750° C.) and annealing time will depend on the product size and thickness. The alloy article can be annealed in an atmosphere such as hydrogen, vacuum, nitrogen, or a combination thereof. If desired, the second elongated form can be annealed either at a temperature above the order-disorder temperature or at a temperature below the order-disorder temperature depending on the product application in which the alloy strip product is intended for use. In any case the product should be cooled at a cooling rate high enough to maintain the desired microstructure and prevent further precipitation during cooling. The cooling rate is selected in agreement with the product size and thickness. The final product form is characterized by a good combination of mechanical and magnetic properties and high electrical resistivity.

The alloy of this invention and articles made therefrom can be produced by powder metallurgy techniques including powder spray and coating techniques known to those skilled in the art. It is also contemplated that parts and components can be made from the alloy powder by additive manufacturing processes.

Strip and sheet forms of the alloy of this invention can be further processed into useful finished or semi-finished parts such as laminations, stampings, and other forms for making electromagnetic devices including, but not limited to, electric motors and generators, transformers, inductors, choke coils, actuators, fuel injectors, and other electromotive devices. The preferred heat-treating temperature for stress relieving of finished or semi-finished parts is in the range of 752-1382° F. (400-750° C.) in an inert atmosphere. The stress relief annealing time will depend on the part size and thickness.

### Working Examples

In order to demonstrate the novel combination of properties provided by the alloy of this invention, 13 example heats were vacuum induction melted and cast as 40-lb. (18.1 kg) ingots. The weight percent chemistries of the heats are presented in Table 1 below. The balance of each composition is iron and usual impurities.

TABLE 1

| | | | | | | | |
|---|---|---|---|---|---|---|---|
| Heat ID | Cr | Si | Co | Mn | B | Zr | Ni |

Invention

| | | | | | | | |
|---|---|---|---|---|---|---|---|
| 3036 | 3.25 | 5.15 | 1 | 0 | 0 | 0 | 0 |
| 3041 | 3.25 | 5.15 | 2.5 | 0.5 | 0 | 0 | 0 |
| 3042 | 3.25 | 5.15 | 4 | 1 | 0 | 0 | 0 |
| 3043 | 2.25 | 5.15 | 1 | 0.5 | 0 | 0 | 0 |
| 3044 | 2.25 | 5.15 | 2.5 | 1 | 0 | 0 | 0 |
| 3045 | 2.25 | 5.15 | 4 | 0.5 | 0 | 0 | 0 |
| 3046 | 1.5 | 5.15 | 1 | 1 | 0 | 0 | 0 |
| 3037 | 1.5 | 5.15 | 1.5 | 0 | 0 | 0 | 0 |
| 3047 | 1.5 | 5.15 | 4 | 0.5 | 0 | 0 | 0 |

Comparative

| | | | | | | | |
|---|---|---|---|---|---|---|---|
| 3038 | 3.25 | 5.15 | 0 | 0 | 0.3 | 0 | 0 |
| 3039 | 3.25 | 5.15 | 0 | 0 | 0.5 | 0 | 0 |
| 3040 | 3.25 | 5.15 | 0 | 0 | 0.1 | 0 | 0 |
| 3058 | 2.26 | 5.15 | 0 | 0.16 | 0.02 | 0 | 0.01 |

Heat Nos. 3036, 3041-3047, and 3037 are representative of the alloy according to the present invention. Heat Nos. 3038-3040 and 3058 are comparative alloys.

The ingots were processed to strip form as follows. The ingots were homogenized in the temperature range of 1652-2282° F. (900-1250° C.) for different durations that were selected based on the ingot size. The homogenized ingots were forged from 3.5-inch (8.9 cm) square to 5-inch (12.7 cm) width by 0.25-inch (0.635 cm) thickness slabs. The slabs were hot rolled in the range of 1472-2102° F. (800-1150° C.) to different thicknesses of strip. The hot rolled strips were reheated at a temperature of 392-1472° F. (200-800° C.) and warm rolled. After warm rolling to final thickness, the strips were cooled to room temperature. The final thickness (Thk.) of the strip sample from each heat is shown in Table 2 below in inches.

Also, set forth in Table 2 are the results of magnetic testing of the strip samples from the heats in Table 1 including the Electrical Resistivity in micro-ohm-centimeters (μΩ-cm), maximum saturation induction (Bₘ) in kilogauss (kG), coercivity in oersteds (Oe), and DC permeability (unitless). Specimens in Condition A were warm rolled and not annealed. Specimens in Condition B were annealed at 1472° F. (800° C.) for 10 minutes after warm rolling.

TABLE 2

| | | | | DC Magnetic Properties | | | | | |
|---|---|---|---|---|---|---|---|---|---|
| | | Elec. | | Induction | | Coercivity | | Permeability | |
| | | Res. | | (Bₘ) | | (Hₘ) | | (μₘ) | |
| Heat | | Cond. | | | | | | | |
| ID | Thk. | A | B | A | B | A | B | A | B |

Invention

| | | | | | | | | | |
|---|---|---|---|---|---|---|---|---|---|
| 3036 | 0.026 | 91 | 86 | 18.9 | 18.9 | 3.37 | 0.499 | 658 | 5125 |
| 3041 | 0.025 | 89.5 | 83 | 14.6 | 14.6 | 4.52 | 0.443 | 298 | 2743 |
| 3042 | 0.028 | 88 | 90 | 18.5 | 19.5 | 3.87 | 0.319 | 633 | 7247 |
| 3043 | 0.019 | 81.6 | 87 | 16.8 | 16.9 | 5.11 | 0.288 | 599 | 8058 |
| 3044 | 0.026 | 88 | 88 | 17 | 17.1 | 3.01 | 0.285 | 782 | 7910 |
| 3045 | 0.028 | 74.8 | 72 | 19.5 | 19.5 | 2.58 | 0.296 | 1006 | 11,100 |
| 3046 | 0.03 | 71.5 | 74.4 | 18.6 | 18.9 | 4.34 | 0.355 | 627 | 8756 |
| 3037 | 0.025 | 77.2 | 85 | 17.4 | 17.4 | 2.67 | 0.324 | 729 | 7219 |
| 3047 | 0.024 | 69 | 68 | 19.2 | 19 | 4.17 | 0.333 | 657 | 10,700 |

Comparative

| | | | | | | | | | |
|---|---|---|---|---|---|---|---|---|---|
| 3038 | 0.014 | 99.5 | 99 | 16.6 | 15.2 | 3.57 | 0.667 | 869 | 4111 |
| 3039 | 0.026 | 94.8 | 96 | 19.2 | 18.7 | 3.82 | 0.5 | 828 | 6797 |
| 3040 | 0.027 | 103 | 102 | 12.3 | 12.4 | 4.78 | 0.77 | 416 | 3099 |
| 3058 | 0.03 | 82 | 91 | 17.8 | 18.3 | 3.27 | 0.525 | 698 | 4970 |

The terms and expressions which are employed in this specification are used as terms of description and not of limitation. There is no intention in the use of such terms and expressions of excluding any equivalents of the features shown and described or portions thereof. It is recognized that various modifications are possible within the invention described and claimed herein.

1. A soft magnetic alloy having good formability, said alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 0.1-7 |
| L | 0.1-10 |
| M′ | up to 7 |
| M″ | up to 7 |
| R | up to 1 |

and the balance of the alloy is iron and usual impurities.

2. The soft magnetic alloy claimed in claim 1 which contains at least about 0.5% L.

3. The soft magnetic alloy claimed in claim 2 which contains not more than about 7% L.

4. The soft magnetic alloy claimed in claim 1 which contains at least about 0.75% L.

5. The soft magnetic alloy claimed in claim 4 which contains not more than about 6% L.

6. The soft magnetic alloy claimed in claim 1 which contains at least about 0.5% M.

7. The soft magnetic alloy claimed in claim 6 which contains not more than about 6% M.

8. The soft magnetic alloy claimed in claim 7 which contains at least about 1% M.

9. The soft magnetic alloy as claimed in claim 1 wherein the alloy contains not more than about 0.1% carbon, not more than about 0.1% nitrogen, and not more than about 0.1% sulfur when the alloy contains one or more elements that form or are likely to form carbides, nitrides, carbonitrides, and/or sulfides in the alloy.

10. A soft magnetic alloy having good formability, said alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 0.5-7 |
| L | 0.5-7 |
| M′ | up to 5 |
| M″ | 5 max. |
| R | up to 1 |

and the balance of the alloy is iron and usual impurities.

11. The soft magnetic alloy claimed in claim 10 which contains at least about 0.75% L.

12. The soft magnetic alloy claimed in claim 11 which contains not more than about 5% L.

13. The soft magnetic alloy claimed in claim 10 which contains at least about 1% M.

14. The magnetic alloy claimed in claim 13 which contains not more than about 6% M.

15. The soft magnetic alloy as claimed in claim 15 wherein the alloy contains not more than about 0.1% carbon, not more than about 0.1% nitrogen, and not more than about 0.1% sulfur when the alloy contains one or more elements that form or are likely to form carbides, nitrides, carbonitrides, and/or sulfides in the alloy.

16. A soft magnetic alloy having good formability, said alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 1-6 |
| L | 0.75-5 |
| M′ | 0.1-3 |
| M″ | 3 max. |
| R | up to 1 |

and the balance of the alloy is iron and usual impurities.

17. The soft magnetic alloy claimed in claim 16 wherein the alloy contains not more than about 0.1% carbon, not more than about 0.1% nitrogen, and not more than about 0.1% sulfur when the alloy contains one or more elements that form or are likely to form carbides, nitrides, carbonitrides, and/or sulfides in the alloy.

18. A soft magnetic alloy having good formability, said alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 0.5-7 |
| L | up to 7 |
| M′ | up to 7 |
| M″ | up to 7 |
| R | up to 1 |

and the balance of the alloy is iron and usual impurities.

19. The soft magnetic alloy claimed in claim 18 wherein Si, M, L, M′, M″, and R have the following ranges in weight percent:

| | |
|---|---|
| Si | 4-7 |
| M | 0.5-7 |
| L | <5 |
| M′ | 0.05-5 |
| M″ | <5 |
| R | up to 1 |

20. The soft magnetic alloy claimed in claim 18 wherein Si, M, L, M′, M″, and R have the following ranges in weight percent:
Si 4-7

| | |
|---|---|
| M | 0.5-7 |
| L | <5 |
| M′ | 0.2-4 |
| M″ | <3 |
| R | up to 1 |

21. The soft magnetic alloy as claimed in claim 18 wherein the alloy contains not more than about 0.1% carbon, not more than about 0.1% nitrogen, and not more than about 0.1% sulfur when the alloy contains one or more elements that form or are likely to form carbides, nitrides, carbonitrides, and/or sulfides in the alloy.

22. A method of making a steel alloy product from a soft magnetic alloy comprising the steps of:
melting an alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 0.1-7 |
| L | 0.1-10 |
| M′ | up to 7 |
| M″ | up to 7 |
| R | up to 1 |

and the balance of the alloy is iron and usual impurities;
casting the alloy into an ingot;
thermomechanically processing said ingot to provide an intermediate elongated product form having a thickness less than about 2 in.;
cooling the intermediate elongated product; and then
mechanically working the intermediate elongated product form to produce a thin-gauge elongated product.

23. The method claimed in claim 22 wherein the step of thermomechanically working consists of hot rolling, warm rolling, or a combination of hot and warm rolling.

24. The method as claimed in claim 22 wherein the mechanical working step consists of warm rolling, cold rolling, or a combination of warm and cold rolling the intermediate elongated product form.

25. The method as claimed in claim 22 comprising the step of heating the intermediate elongated product to a temperature above the order-disorder transition temperature.

26. The method as claimed in claim 25 comprising the step of cooling the intermediate elongated product from said temperature at a rate that is effective to inhibit the formation of an ordered phase in the alloy.

27. A thin-gauge article formed from an alloy having the chemical formula
Fe_{100-a-b-c-d-e-f}SiₐM_{b}L_{c}M′_{d}M″ₑR_{f}
wherein M is one or both of Cr and Mo;
L is one or both of Co and Ni;
M′ is selected from the group consisting of Al, Mn, Cu, Ge, Ga, and a combination thereof;
M″ is selected from the group consisting of Ti, V, Hf, Nb, W, and a combination thereof;
R is selected from the group consisting of B, Zr, Mg, P, Ce, and a combination thereof; and
wherein Si, M, L, M′, M″, and R have the following ranges in weight percent:

| | |
|---|---|
| Si | 4-7 |
| M | 0.1-7 |
| L | 0.1-10 |
| M′ | up to 7 |
| M″ | up to 7 |
| R | up to 1 |

and the balance of the alloy is iron and usual impurities, said thin-gauge article being characterized by a high magnetic saturation induction, high magnetic permeability, and good ductility.
